(19) United States
(12) Patent Application Publication
(10) Pub. No.: US 2013/0100110 A1
(43) Pub. Date: Apr. 25, 2013

(54) STEREO-SCOPIC IMAGE PANEL, STEREO-SCOPIC IMAGE DISPLAY APPARATUS HAVING THE SAME AND DRIVING METHOD THEREOF

(71) Applicants: Hyun LEE, Daejeon-si (KR); Eung Don LEE, Daejeon-si (KR)

(72) Inventors: Hyun LEE, Daejeon-si (KR); Eung Don LEE, Daejeon-si (KR)

(73) Assignee: Electronics and Telecommunications Research Institute, Daejeon (KR)

(21) Appl. No.: 13/559,694

(22) Filed: Jul. 27, 2012

(30) Foreign Application Priority Data
Oct. 19, 2011 (KR) 10-2011-0107165

(51) Int. Cl. G06F 3/038; G02F 1/1335

(52) U.S. Cl. 345/212; 349/15

(57) ABSTRACT

The present invention provides a stereoscopic image panel making it possible to freely watch a stereoscopic image by being equipped with parallax barriers, a stereoscopic image display apparatus including the stereoscopic image panel, and a method of driving the stereoscopic image panel. A stereoscopic image panel according to the present invention includes: a liquid crystal layer; a first electrode unit positioned opposite to one side of the liquid crystal layer; a second electrode unit including first, second, and third electrodes positioned such that one side of each of the electrodes is opposite the other side of the liquid crystal layer; and a third electrode unit positioned opposite the other side of the second electrode.

### CROSS-REFERENCE TO RELATED APPLICATIONS

This application claims the benefit of priority of Korean Patent Application No. 10-2011-0107165 filed on Oct. 19, 2011, all of which is incorporated by reference in their entirety herein.

### BACKGROUND OF THE INVENTION

1. Field of the Invention

The present invention relates to a stereoscopic image panel, a stereoscopic image display apparatus having the same, and a driving method thereof, and more particularly, to a stereoscopic image panel that provides a glasses-free stereoscopic image, an stereoscopic image display apparatus having the stereoscopic image panel, and a method of driving the stereoscopic image panel.

2. Discussion of the Related Art

In general, the technology related to stereoscopic image display apparatuses is used in various fields, not only in the image-related field, but the aerospace industry and the art industry, including consumer-electronics and telecommunication industries. The stereoscopic image display apparatuses largely employ glasses type and glasses-free type of stereoscopic image-generating techniques.

The glasses type is classified into a coded glasses type with wavelength option, a polarized glasses type using a light blocking effect of a polarizer, and a time-division glasses type alternately providing left and right images within the time of the residual image of eyes. However, the glasses type has a problem in that it is inconvenient to put on glasses when watching a stereoscopic image and eye strain is caused in long time watching. Therefore, researches of developing a glasses-free type of stereoscopic image-generating technique have been conducted to solve such a problem as mentioned above. A method in the researches has been disclosed in Korean Patent Publication No. 2007-0023849 (2007.03.02).

The published invention adopts a structure of bonding a multilayer of parallax barriers on an LCD panel. Therefore, the published invention makes it possible to adjust a watching distance and a viewing angle for a stereoscopic image display by driving only the barrier corresponding to the watching distance of a viewer. However, in the published invention, light is partially transmitted through the gaps between the micro-barrier electrodes, so that crosstalk may be generated. Therefore, the published invention may have a problem in that the quality of a stereoscopic image is deteriorated and bonding becomes difficult.

### SUMMARY OF THE INVENTION

It is an object of the present invention to provide a stereoscopic image panel making it possible to freely watch a stereoscopic image by being equipped with parallax barriers, a stereoscopic image display apparatus including the stereoscopic image panel, and a method of driving the stereoscopic image panel.

To accomplish the above-mentioned objects, the present invention provides a stereoscopic image panel including: a liquid crystal layer; a first electrode unit positioned opposite to one side of the liquid crystal layer; a second electrode unit including first, second, and third electrodes positioned such that one side of each of the electrodes is opposite to the other side of the liquid crystal layer; and a third electrode unit positioned opposite to the other side of the second electrode.

A plurality of the first, second, and third electrodes may be provided respectively and the end of one side of the first electrode may be positioned adjacent to the end of one side of the second electrode, and the end of the other side of the second electrode may be positioned adjacent to the end of one end of the third electrode.

The first, second, and third electrodes may include transparent electrodes.

Further, the present invention provides a stereoscopic image display apparatus that includes the stereoscopic image panel, including: a measuring unit that measures positional information of a viewer; a control unit that selects the first, second, and third electrodes of the stereoscopic image panel on the basis of the positional information of the viewer provided from the measuring unit; and a driving circuit unit that applies driving power to the first, second, and third electrodes selected by the control unit.

The stereoscopic image display apparatus may further include an image panel that is disposed at a side of the stereoscopic image panel and reproduces images that are the base of a stereoscopic image.

Further, the present invention provides a method of driving a stereoscopic image panel, which includes: a liquid crystal layer; a first electrode unit positioned opposite to one side of the liquid crystal layer; a second electrode unit including first, second, and third electrodes positioned such that one side of each of the electrodes is opposite to the other side of the liquid crystal layer; and a third electrode unit positioned opposite to the other side of the second electrode, includes changing the state of the liquid crystal layer by selectively applying a driving voltage to at least one or more of the firte, second, and third electeodes.

The first, second, and third electrodes may include transparent electrodes.

A plurality of the first, second, and third electrodes may be provided, respectively, the end of one side of the first electrode may be positioned adjacent to the end of one side of the second electrode, and the end of the other side of the second electrode may be positioned adjacent to the end of one end of the third electrode.

The method of driving a stereoscopic image panel may further include: in a case that the liquid crystal layer is configured to block light when an electric field is formed, and to transmit light when the electric field is not formed in the liquid crystal layer, a) forming a first state transition in the liquid crystal layer by applying the driving voltage between the first electrode unit and the third electrode and by generating a short circuit between the first electrode unit and the second electrode; b) forming a second state transition in the liquid crystal layer by applying the driving voltage between the first electrode unit and the third electrode and by generating a short circuit between the first electrode unit and the third electrode; and c) forming a third state transition in the liquid crystal layer by applying the driving voltage between the first electrode unit and the third electrode and by generating a short circuit between the first electrode unit and the first electrode.

The method of driving a stereoscopic image panel may further include: in a case that the liquid crystal layer is configured to transmit light when an electric field is formed, and to block light when the electric field is not formed in the liquid crystal layer, a) forming a first state transition in the liquid crystal layer by applying the driving voltage between the first electrode unit and the second electrode; b) forming a second state transition in the liquid crystal layer by applying the driving voltage between the first electrode unit and the third electrode; and c) forming a third state transition in the liquid crystal layer by applying the driving voltage between the first electrode unit and the first electrode.

According to a stereoscopic image panel, a stereoscopic image display apparatus including the stereoscopic image panel, and a method of driving the stereoscopic image pane of the present invention, it is possible to implement a smooth and free stereoscopic image by minimizing discontinuity generated when moving a barrier and minimizing crosstalk.

Further, the technical effect of the present invention described above is not limited to the effect described above and other technical effects not stated herein can be clearly understood by those skilled in the art from the following description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a configuration diagram showing a stereoscopic image display apparatus according to an exemplary embodiment of the present invention;

FIG. 2 is a configuration diagram showing the structure of the stereoscopic image panel according to the exemplary embodiment;

FIGS. 3A to 3C are configuration diagrams showing a transition state of a stereoscopic image panel according to another exemplary embodiment of the present invention; and

FIGS. 4A to 4C are configuration diagrams showing a transition state of a stereoscopic image panel according to another exemplary embodiment of the present invention.

### DETAILED DESCRIPTION OF THE PREFERRED EMBODIMENTS

Hereinafter, a stereoscopic image display apparatus according to an exemplary embodiment of the present invention and a driving method thereof will be described in detail with reference to the accompanying drawings.

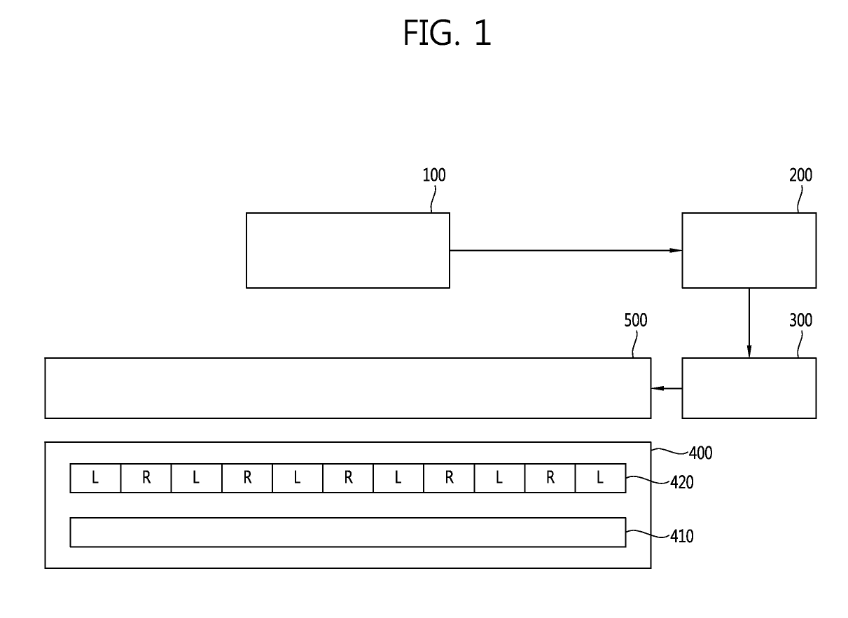

FIG. 1 is a configuration diagram showing a stereoscopic image display apparatus according to an exemplary embodiment of the present invention.

As shown in FIG. 1, a stereoscopic image display apparatus includes a measuring unit 100, a control unit 200, a driving circuit unit 300, an image panel 400, and a stereoscopic image panel 500.

The measuring unit 100 is provided to measure the positional information of a viewer, such as the distance from the viewer, the left and right positions, and face inclination. A measuring sensor and a camera may be used as the measuring unit 100. For example, an IR (Infrared Ray), ultrasonic waves or a laser sensor may be selectively used as the measuring sensor, and a regular camera such as a 2D camera and a stereo-camera may be selectively used as the camera.

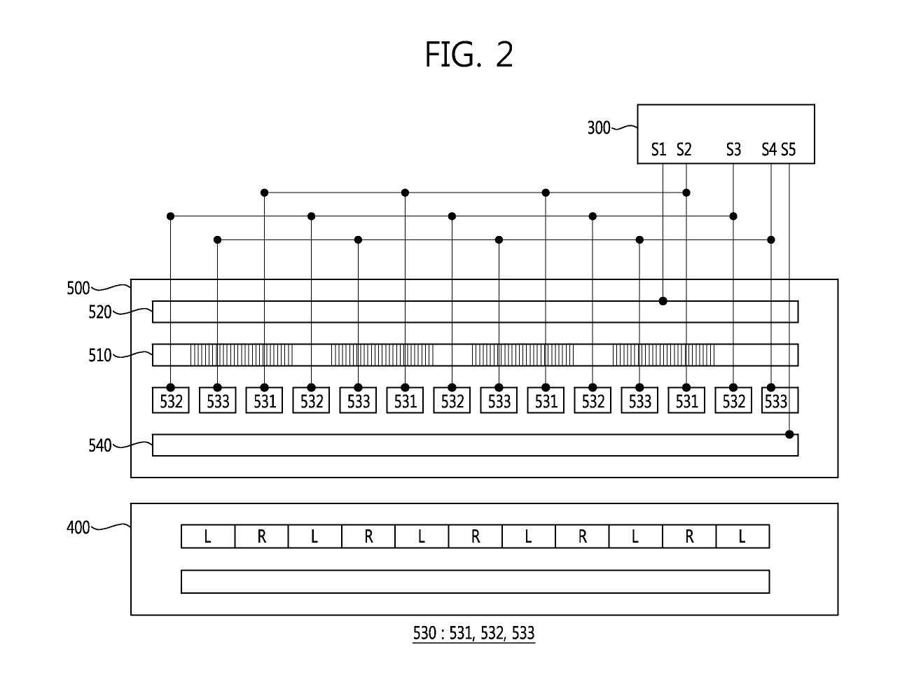

The control unit 200 selects electrode units 520, 530, and 540 (see FIG. 2) of the stereoscopic image panel 500 on the basis of the positional information of the viewer transmitted from the measuring unit 100. Further, the driving circuit unit 300 is provided to apply a driving voltage Vb to the electrode units 520, 530, and 540 selected by the control unit 200.

The image panel 400 may be a general display in order to reproduce an image in a pixel unit. The image panel 400 is positioned ahead of a backlight 410. The image panel 400 includes an image panel 420 composed of right eye pixels R that are shown to the viewer's right eye and left eye pixels L that are shown to the viewer's left eye.

FIG. 2 is a configuration diagram showing the structure of the stereoscopic image panel according to the exemplary embodiment.

As shown in FIG. 2, the stereoscopic image panel 500 according to the exemplary embodiment is positioned at a side of the image panel 400. The stereoscopic image panel 500 is provided to provide a viewer with a stereoscopic image on the basis of the images provided from the image panel 400. The stereoscopic image panel 500 may include a liquid crystal layer 510, a first electrode unit 520, a second electrode unit 530, and a third electrode unit 540.

The liquid crystal layer 510 blocks or transmits the image reproduced from the image panel 400. The liquid crystal layer 510 may be used in a (normally black) way of transmitting light when a predetermined electric field is generated and of blocking light when an electric field is not generated, and a (normally white) way of blocking light when a predetermined electric field is generated and of transmitting light when an electric field is not generated in the liquid crystal layer 510.

The first electrode unit 520 is disposed at a side of the liquid crystal layer 510. The first electrode unit 520 may be positioned with one side opposite the liquid crystal layer 510 throughout the entire area of the liquid crystal layer 510.

The second electrode unit 530 is positioned opposite the liquid crystal layer 510, on the other side opposite the side where the first electrode unit 520 is positioned, with respect to the liquid crystal layer 510. The second electrode unit 530 includes first, second, and third electrodes 531, 532, and 533. The first, second, and third electrodes 531, 532, and 533 are positioned such that one side of each of the electrodes is opposite the liquid crystal layer 510 throughout the liquid crystal layer 510. A plurality of first, second, and third electrodes 531, 532, and 533 may be alternately disposed. For example, the end of one side of the first electrode 531 may be positioned adjacent to the end of one side of the second electrode 532 and the end of the other side of the second electrode 532 may be positioned adjacent to the end of one end of the third electrode 533.

The third electrode unit 540 is positioned opposite the other side of the second electrode unit 530 having one side opposite the liquid crystal layer 510. Further, the third electrode unit 540 may be positioned opposite the liquid crystal layer 510 throughout the entire area of the liquid crystal layer 510.

The first, second, and third electrode units 520, 530, and 540 may be implemented by ITO (Indium Tin Oxide) transparent electrodes. Further, although the exemplary embodiment describes when the second electrode unit 530 is positioned between the liquid crystal layer 510 and the third electrode unit 540, the second electrode unit 530 may be positioned between the liquid crystal layer 510 and the first electrode unit 520, in accordance with embodiments.

The operational state of the stereoscopic image panel according to the exemplary embodiment is described hereafter in detail with reference to the accompanying drawings. The (normally white) way of blocking light when a predetermined electric field is generated in a liquid crystal layer and of transmitting light when an electric field is not generated is exemplified in the following description.

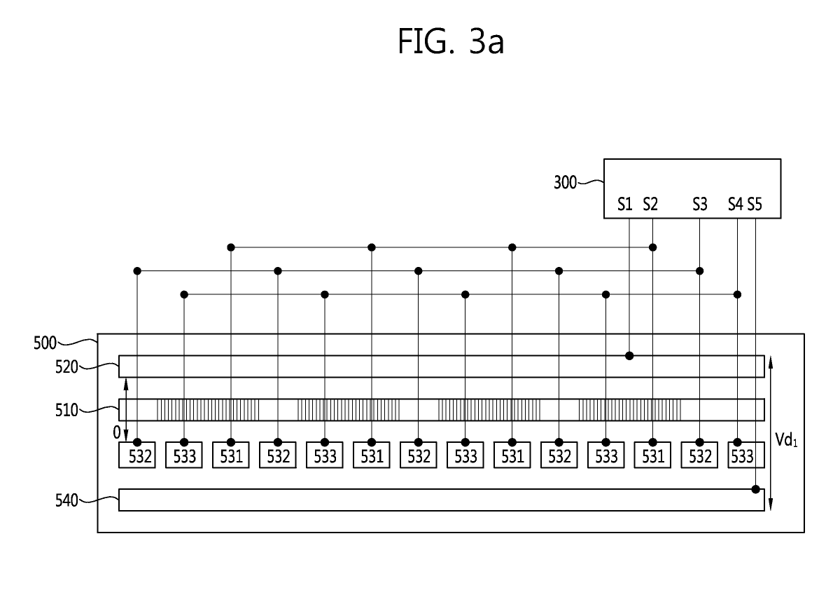

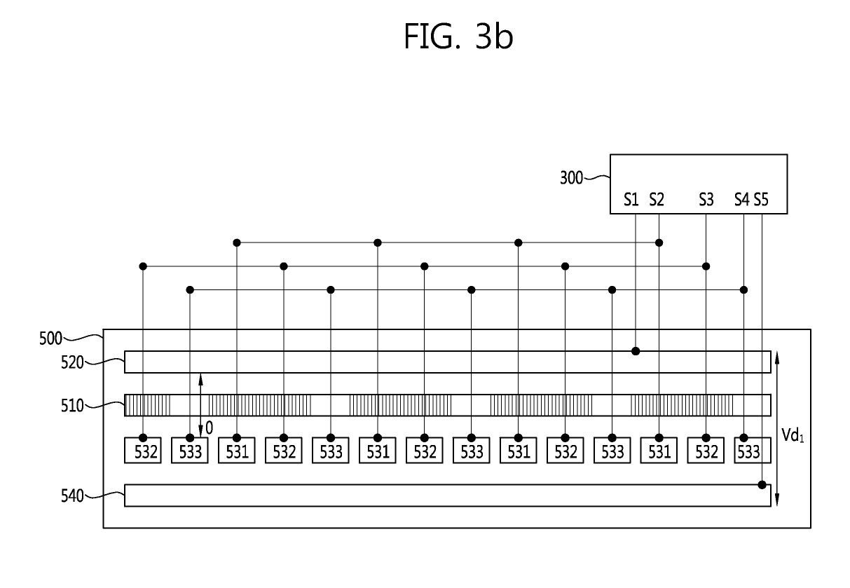

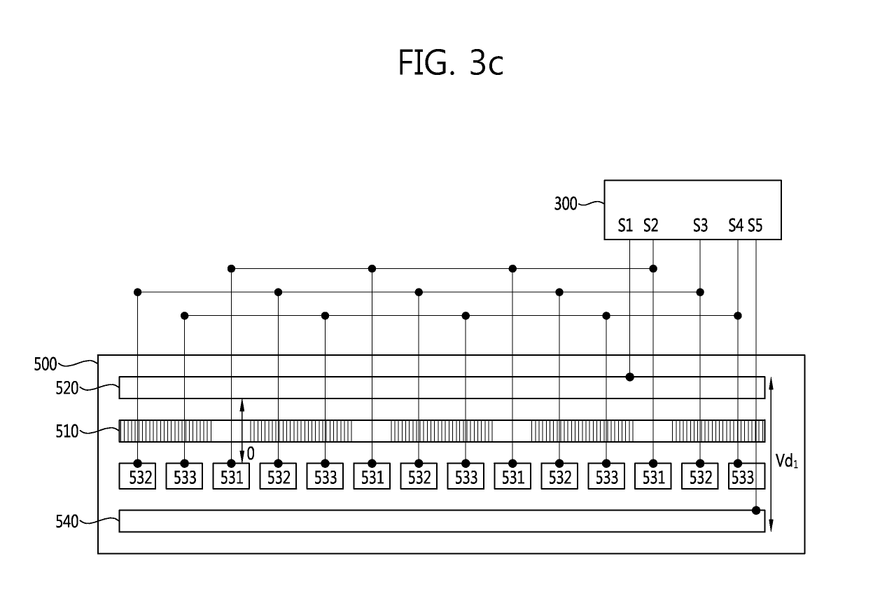

FIGS. 3A to 3C are configuration diagrams showing a transition state of the stereoscopic image panel according to the exemplary embodiment of the present invention.

As shown in FIGS. 3A to 3C, the stereoscopic image panel 500 may have three state transitions in accordance with the driving voltage Vb1 applied to the first, second, and third electrode units 520, 530, and 540. A driving method of three state transitions of the stereoscopic image panel 500 is described in detail with reference to the following Table 1.

TABLE 1

| DLPB operation | |
|---|---|
| state | Driving circuit operated |
| State 1 | s1-s5: driving voltage (Vd1) |
| | applied |
| | s1-s3: short |
| State 2 | s1-s5: driving voltage (Vd1) |
| | applied |
| | s1-s4: short |
| State 3 | s1-s5: driving voltage (Vd1) |
| | applied |
| | s1-s2: short |

In Table 1, s1 indicates connection between the driving circuit unit 300 and the first electrode unit 520, s2 indicates connection between the driving circuit unit 300 and the first electrode 531, s3 indicates connection between the driving circuit unit 300 and the second electrode 532, s4 indicates connection between the driving circuit unit 300 and the third electrode 533, and s5 indicates connection between the driving circuit unit 300 and the third electrode unit 540

FIG. 3A is a diagram showing a first state (State 1) of the stereoscopic image panel according to the exemplary embodiment. The first state is implemented, when a driving voltage Vb1 is applied between s1 and s5 and a short circuit is generated between s1 and s3.

FIG. 3B is a diagram showing a second state (State 2) of the stereoscopic image panel according to the exemplary embodiment. The second state is implemented, when the driving voltage Vb1 is applied between s1 and s5 and a short circuit is generated between s1 and s4.

FIG. 3C is a diagram showing a third state (State 3) of the stereoscopic image panel according to the exemplary embodiment. The third state is implemented, when the driving voltage Vb1 is applied between s1 and s5 and a short circuit is generated between s1 and s2.

It can be seen from FIGS. 3A to 3C that even if the driving voltage Vb1 is applied to the first, second, and third electrode units 520, 530, and 540 such that light is blocked throughout the entire area of the liquid crystal layer 510 in the stereoscopic image panel 500, the voltage differences at sections between the first electrode unit 520 and the first, second, and third electrodes 531, 532, and 533 respectively connected with the driving circuit unit 300 are 0, so that an electric field is not generated in the liquid crystal layer 510 and light can be transmitted.

The short circuit means connection of both terminals through a circuit or an equivalent potential state in the present invention. The most typical method of making the equivalent potential state is to ground both terminals through a circuit.

The operational state of a stereoscopic image panel according to another exemplary embodiment is described hereafter in detail with reference to the accompanying drawings. The (normally black) way of transmitting light when a predetermined electric field is generated layer and of blocking light when an electric field is not generated in a liquid crystal layer is exemplified in the following description.

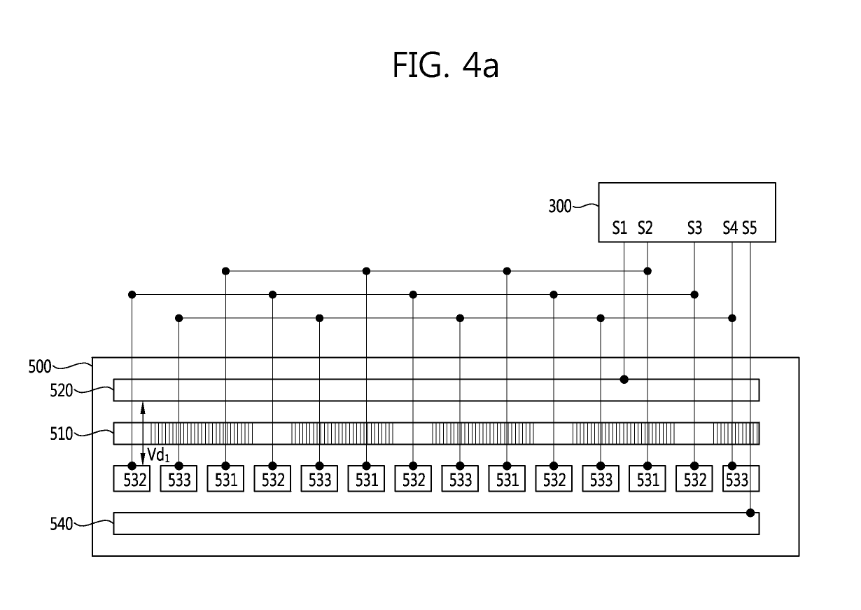

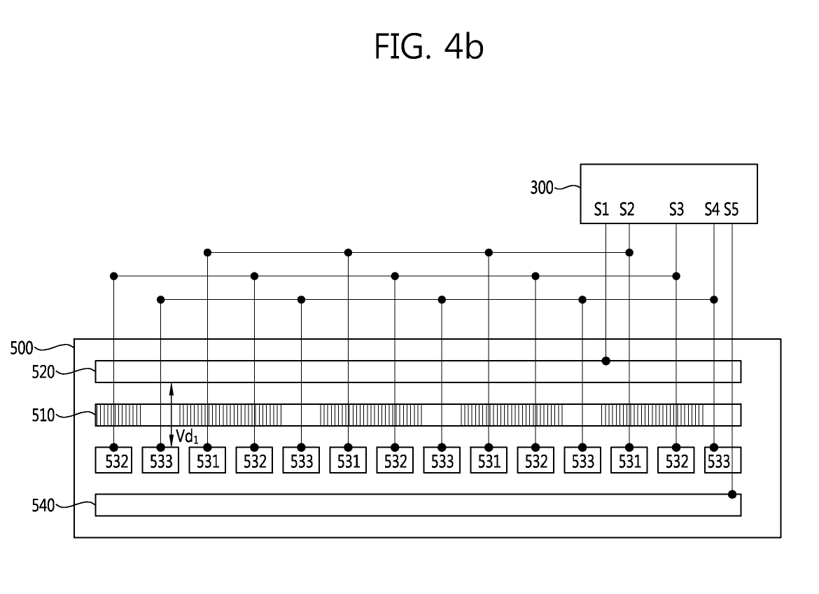

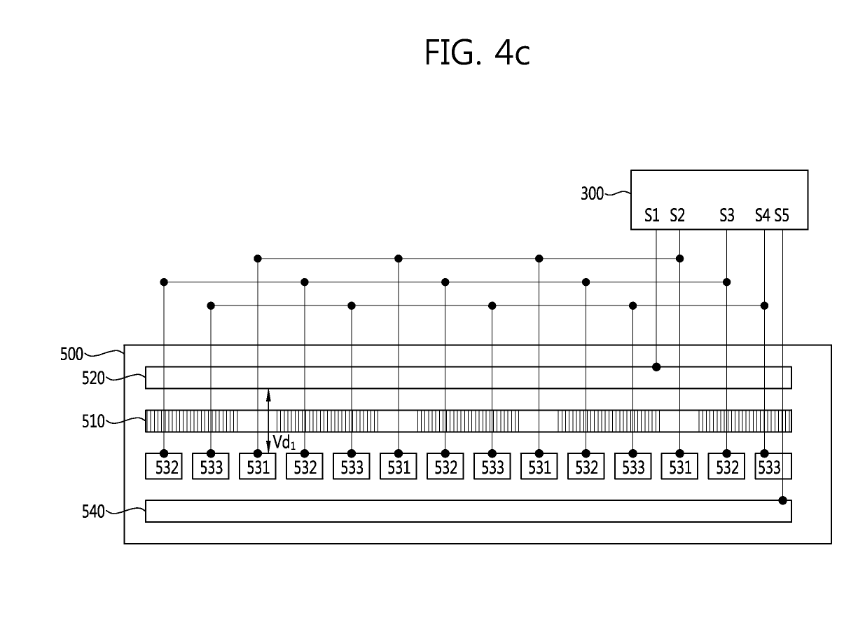

FIGS. 4A to 4C are configuration diagrams showing a transition state of a stereoscopic image panel according to another exemplary embodiment of the present invention.

As shown in FIGS. 4A to 4C, a stereoscopic image panel 500 according to another exemplary embodiment may have three state transitions in accordance with the driving voltage Vb1 applied to the first, second, and third electrode units 520, 530, and 540. A driving method of three state transitions of the stereoscopic image panel 500 is described in detail with reference to the following Table 2.

TABLE 2

| DLPB operation | |
|---|---|
| state | Driving circuit operated |
| State 1 | s1-s3: driving voltage (Vd1) |
| | applied |
| State 2 | s1-s4: driving voltage (Vd1) |
| | applied |
| State 3 | s1-s2: driving voltage (Vd1) |
| | applied |

In Table 2, s1 indicates connection between the driving circuit unit 300 and the first electrode unit 520, s2 indicates connection between the driving circuit unit 300 and the first electrode 531, s3 indicates connection between the driving circuit unit 300 and the second electrode 532, s4 indicates connection between the driving circuit unit 300 and the third electrode 533, and s5 indicates connection between the driving circuit unit 300 and the third electrode unit 540.

FIG. 4 is a diagram showing a first state (State 1) of the stereoscopic image panel according to another exemplary embodiment. The first state is implemented, when the driving voltage Vb1 is applied between s1 and s3.

FIG. 4 is a diagram showing a second state (State 2) of the stereoscopic image panel according to another exemplary embodiment. The second state is implemented, when the driving voltage Vb1 is applied between s1 and s4.

FIG. 4 is a diagram showing a third state (State 3) of the stereoscopic image panel according to another exemplary embodiment. The third state is implemented, when the driving voltage Vb1 is applied between s1 and s2.

As described above, the stereoscopic image panel, a stereoscopic image display apparatus including the stereoscopic image panel, and a method of driving the stereoscopic image panel according to the present invention, since the transmitting area and the blocking area of the liquid crystal layer 510 transit into the third state in accordance with the driving voltage Vb1 applied to the first, second, and third electrode units 520, 530, and 540 by the driving circuit unit 300, can provide a continuous glasses-free stereoscopic image in accordance with changes in position and watching distance of a viewer.

The embodiments of the present invention which are described above and illustrated in the drawings should not be construed as limiting the spirit of the present invention. The protection scope of the present invention is limited only by claims and the present invention may be modified in various ways by those skilled in the art without departing from the scope of the present invention. Therefore, the changes and modifications will be included in the protection scope of the present invention, as long as those are apparent to those skilled in the art.

What is claimed is:

1. A stereoscopic image panel comprising:
a liquid crystal layer;
a first electrode unit positioned opposite to one side of the liquid crystal layer;
a second electrode unit including first, second, and third electrodes positioned such that one side of each of the electrodes is opposite to the other side of the liquid crystal layer; and
a third electrode unit positioned opposite to the other side of the second electrode.

2. The stereoscopic image panel of claim 1, wherein a plurality of the first, second, and third electrodes are provided respectively, and the end of one side of the first electrode is positioned adjacent to the end of one side of the second electrode, and the end of the other side of the second electrode is positioned adjacent to the end of one end of the third electrode.

3. The stereoscopic image panel of claim 1, wherein the first, second, and third electrodes include transparent electrodes.

4. A stereoscopic image display apparatus that includes the stereoscopic image panel of claim 1, comprising:
a measuring unit that measures positional information of a viewer;
a control unit that selects the first, second, and third electrodes of the stereoscopic image panel on the basis of the positional information of the viewer provided from the measuring unit; and
a driving circuit unit that applies driving power to the first, second, and third electrodes selected by the control unit.

5. The apparatus of claim 4, further comprising an image panel that is disposed at a side of the stereoscopic image panel and reproduces images that are the base of a stereoscopic image.

6. A method of driving a stereoscopic image panel, which includes: a liquid crystal layer; a first electrode unit positioned opposite to one side of the liquid crystal layer; a second electrode unit including first, second, and third electrodes positioned such that one side of each of the electrodes is opposite to the other side of the liquid crystal layer; and a third electrode unit positioned opposite to the other side of the second electrode,
the method comprising:
changing the state of the liquid crystal layer by selectively applying a driving voltage to at least one or more of the firte, second, and third electeodes.

7. The stereoscopic image panel of claim 6, wherein the first, second, and third electrodes include transparent electrodes.

8. The method of claim 6, wherein a plurality of the first, second, and third electrodes are provided, respectively, the end of one side of the first electrode is positioned adjacent to the end of one side of the second electrode, and the end of the other side of the second electrode is positioned adjacent to the end of one end of the third electrode.

9. The method of claim 8, further comprising:
in a case that the liquid crystal layer is configured to block light when an electric field is formed, and to transmit light when the electric field is not formed in the liquid crystal layer,
a) forming a first state transition in the liquid crystal layer by applying the driving voltage between the first electrode unit and the third electrode and by generating a short circuit between the first electrode unit and the second electrode;
b) forming a second state transition in the liquid crystal layer by applying the driving voltage between the first electrode unit and the third electrode and by generating a short circuit between the first electrode unit and the third electrode; and
c) forming a third state transition in the liquid crystal layer by applying the driving voltage between the first electrode unit and the third electrode and by generating a short circuit between the first electrode unit and the first electrode.

10. The method of claim 8, further comprising:
in a case that the liquid crystal layer is configured to transmit light when an electric field is formed, and to block light when the electric field is not formed in the liquid crystal layer,
a) forming a first state transition in the liquid crystal layer by applying the driving voltage between the first electrode unit and the second electrode;
b) forming a second state transition in the liquid crystal layer by applying the driving voltage between the first electrode unit and the third electrode; and
c) forming a third state transition in the liquid crystal layer by applying the driving voltage between the first electrode unit and the first electrode.
